(19) United States
(12) Patent Application Publication
(10) Pub. No.: US 2005/0247213 A1
(43) Pub. Date: Nov. 10, 2005

(54) Method of identifying particular attributes of food products consistent with consumer needs and/or desires

(76) Inventor: George E. Slilaty, Binghamton, NY (US)

Correspondence Address: Hinman, Howard & Kattell, 700 Security Mutual Building, Binghamton, NY, 13901, US

(21) Appl. No.: 10/837,693

(22) Filed: May 4, 2004

(51) Int. Cl. A23B 4/00

(52) U.S. Cl. 99/485

(57) ABSTRACT

There is provided a method and system for identifying food products according to a specific nutritional code such that a consumer of the products will be able to readily ascertain whether the products meet his/her own personal nutritional lifestyle. The method and system defined herein also enables both the food manufacturer and the food retailer to have inputs to the database of the system, thus further assuring effective implementation thereof.

### TECHNICAL FIELD

The invention relates to food identification and especially to food identification methodology designed to assist human consumers in the proper selection of foods necessary for a safe and effective diet designed particularly to meet their own particular nutritional lifestyle needs.

### BACKGROUND OF THE INVENTION

As is known, today's human consumers have a multitude of different dietary needs and desires, depending on their own health situation (e.g., overweight, diabetic, lactose-intolerant), personal beliefs (e.g., vegetarians, organically grown only), religious principles (e.g., Kosher), etc. As is also known, it is often relatively difficult for such consumers with particular needs and desires to easily ascertain from various food products whether the particular product they are purchasing meets these needs and desires, especially from a single retail establishment (e.g., Wegmans, Winn-Dixie, Publix). For example, a consumer may know the type of food product (e.g., a meat item) he/she is purchasing, but typically does not know if the item was treated in a manner (e.g., with growth stimulants) that the purchaser finds inappropriate. The consumer may not readily ascertain whether a certain vegetable is organically grown. To purchase some food products according to religious principles (e.g., Kosher), the purchaser must usually seek out a separate location in the retail establishment for such products, or a different retailer that specializes in such products only. Still further, without referring to a separate chart or other reference media (e.g., a diet regimen provided by one's personal physician), the purchaser does not readily know if the particular food item is ideally suited for his/her own personal nutritional lifestyle (e.g., heart health, weight control, performance, cancer avoidance, non-allergic, etc.). Thus, by the term “nutritional lifestyle” as used herein is meant a human consumer's needs and/or desires necessary to satisfy particular final results, including, for example, overcoming obesity, eliminating hypertension, combating diabetes, allergen avoidance, avoiding lactose, attaining certain performance goals, meeting religious and personal dietary requirements (such as vegetarian diets) and the like (including, by way of example, even finding the lowest cost food product from several differently packaged such food products (e.g., a certain cheese), even just learning desirable nutritional aspects of such food products). With respect to various diseases such as diabetes, obesity, heart disease, cancer and others, this term is meant to include both substantial prevention thereof and, if the disease is already present, substantial prevention of further adverse aspects thereof (in other words, livable accommodation of the disease with minimal, if any, negative side effects).

One of the most significant of the above consumer needs is that concerning the personal health of the consumer. The concerns in this particular group are those involving disease prevention and control, weight management, and allergen avoidance. (This is not meant to diminish the desire for excellent personal performance, a highly popular trend today as evidenced by the several health clubs and similar establishments presently in operation in this country and in others.) With respect to disease prevention and control, weight management and allergen avoidance, there are some fairly startling statistics available which define how “unhealthy” today's U.S. population is. For example, it is estimated there were about 556,500 deaths in 2004 due to cancer. Additionally, it is estimated that about 65 million persons in the U.S. are affected by one or more types of heart disease. Still further, type II diabetes is estimated to affect 16 million persons, 50 million persons are affected by hypertension, 25 million have gastrointestinal disorders (e.g., acid reflux disease), and, equally discouraging, that at least 60 million persons in this country are obese (more than 20 percent overweight). With further respect to diabetes, hyperglycemia is often found in diabetes mellitus, which alone affects about 15 million persons. Finally, it is estimated that about 7 million persons suffer from some sort of food allergy, the “Big 8” allergy-causing food products being milk, eggs, fish, peanuts, wheat, soybeans, tree nuts and crustaceans (e.g., lobster, shrimp and crabs). These statistics clearly show that many persons today are suffering from many diseases and other health-related problems such as being overweight primarily because of an inadequate diet (in addition, of course, to lack of appropriate exercise, use of tobacco products, etc.). And, it is believed that such an inadequate diet is due, in significant part at least, to lack of proper food selection. And that such lack of proper food selection is primarily due to lack of proper food product identification at the retail establishment where the consumer purchases his/her comestibles.

The U.S. Department of Agriculture (U.S.D.A.) published a “food guide pyramid” in April, 1992 for public use as a dietary aid to better control and monitor individual food consumption. This pyramid is illustrated in FIG. 1, and discloses three essential elements of a healthy diet: proportion, moderation, and variety. Diabetics, for example, are often taught to monitor the use of selected food groups to aid in regulating their dietary needs, and to better control their intake of fats, sodium and sugars. Likewise, a number of diet programs also use food group monitoring to aid in maintaining a healthy diet, and as a guide to controlled weight loss. The base of the food pyramid is designated as the bread, cereal, rice and pasta group, which is generally limited to six to eleven servings per day. A vegetable group is positioned above the base food group on the food pyramid, and is often limited to three to five servings per day. A fruit group is positioned adjacent to the vegetable food group above the base food group. The fruit food group is typically limited to two to four servings per day. A milk, yogurt & cheese group is located above the vegetable food group, and is generally limited to two to three servings per day. A meat, poultry, fish, dry beans, eggs and nut group is positioned above the fruit food group, adjacent to the milk etc. food group. This meat etc. food group is generally limited to two to three servings per day. The tip of the pyramid is occupied by the fats, oils and sweets group, which is to be used sparingly. Users of the food pyramid often find it difficult to reconstruct their food use patterns from meal to meal, and from day to day, for comparison over time.

Other known examples of dietary selection for health concerns are those for determining the proper diet for diabetics. Various caloric diets (ranging from 1,000 calories to 2,800 calories) have been prepared by the American Diabetic Association (A.D.A.) and are used to treat diabetics. Although the A.D.A. diet is a weight reducing diet in many cases, this is not necessarily so. Primarily, the A.D.A. diet is a method of treating and controlling diabetes, and must be a day to day consistency of ratios of carbohydrate, protein and fat for each feeding. Once a certain caloric A.D.A. diet is established for a particular patient in order to control the blood sugar within normal limits, it is a lifetime treatment. It must be adhered to without deviation for life. Each A.D.A. diet is individualized by physician prescription, and can only be changed by the physician. A patient must schedule his or her meals to provide regular caloric intake. Meal planning is necessary to avoid alternating periods of feasting and fasting, resulting in too high or too low blood sugar levels. The amount of meals ranges from three to eight meals per day, typically. One approach to diabetic dietary management involves a system of food exchanges which can provide menu variety while maintaining consistent distribution of daily caloric intake. The exchange list system involves the grouping of foods with similar fat, carbohydrate and protein content into lists allowing the exchange of a portion of one food on a list with another on the same list while composing a menu. One exchange list system has been prepared by a committee of the A.D.A. and the American Dietetic Association in cooperation with the National Institute of Health, which exchange list system was published in 1976. Another publication which contains similar information relative to exchange groups of foods is a publication of the U.S. Department of Agriculture, entitled “Nutritive Value of American Foods—Agricultural Handbook No. 8”. When diabetics are initially diagnosed, they are taught how to use these reference guides in order to maintain a diet prescribed by a medical doctor. In the case of children, these young patients are generally hospitalized until they and their parents understand the guides and know how to use these without error. Because the penalty for misapplying the information is so severe (e.g., illness), followed possibly by extreme results such as blindness, etc., patients may remain hospitalized longer than is medically necessary to stabilize their insulin and food intake One difficulty with the use of such guides for teaching diet control is that it is time consuming to use and subject to error. It is also difficult for a doctor to know when a patient has departed from the diet until such time as an abnormal blood sugar level is diagnosed. At that time, though, cumulative adverse effects from the lack of a controlled diet may have permanently adversely affected the patient's health. Further, while the list systems assist in controlling total calories, and provide information concerning the amount and type of fat present in various foods, the varieties of foods listed are, of necessity, quite limited.

With respect to another health concern (obesity), people who have desired to maintain an appropriate body weight have simply attempted to control the portions of food being consumed. There have been many different types and kinds of methods employed to help control the consumption of food being consumed. People have resorted to weighing the quantities of the food, or otherwise measuring these with utensils such as spoons and measuring cups. Also, the calorie content of the comestibles to be consumed on a daily basis have been counted (with reference, typically, to a separate chart or media such as one provided by the person's personal physician) so that the total number of calories do not exceed a desired total number of calories being consumed. Similarly, the grams of fat content in the food (as provided on the food product's label) have also been counted to ensure that the total number of grams of fat for a given day is not exceeded. Such techniques have often been time-consuming and awkward to accomplish. Thus, the person following such dietary control frequently will become frustrated and not follow the regimen consistently. Thus, the benefits may not be realized as expected.

Various methods of dietary control or food identification are described in the following documents:

### U.S. Letters Patents

| | |
|---|---|
| 4,652,241 | McCarty |
| 4,828,498 | Tilney |
| 4,832,603 | Basil |
| 5,283,865 | Johnson |
| 6,039,576 | Gabig et al |
| 6,428,320 B1 | Archuleta et al |
| 6,431,873 B1 | Flagg |
| 6,585,516 B1 | Alabaster |

### Foreigh Patent Abstracts

| | |
|---|---|
| JP2002183415A | Shigeyoshi |
| JP2003067607A | Koji |

### Additional Citations

In addition to the above, various information on food products can be found at the following World Wide Web URLs:
1. The U.K. Food Standards Agency—http://foodstandards.gov.uk/foodlabelling
2. The U.S.D.A. National Organic Program—http://www.ams.usda.gov/nop

Still further information is available from the Center For Food Marketing at St. Joseph's University in Philadelphia, Pa., and at the National Grocer's Association in Washington, D.C.

With particular attention to the above-listed U.S. Letters Patents and Foreign Abstracts, in U.S. Pat. No. 4,652,241, there is described a system in which a plurality of independent, readily identifiable, movable members are provided, each of which represents a pre-defined food group and portion. By positioning the movable members in cooperative association with meal designating zones, a food consumption, planning and control system is achieved. The plurality of movable members comprise in their entirety, all of the food to be consumed by an individual in one day, and the meal designating zones identify all of the meals to be eaten by that individual during one day. By moving each food designating member from an intake designating zone to a meal designating zone, for each food group and portion consumed during that meal, the individual is apparently able to control and record the food to be consumed, as well as develop varied meals within the desired maximum caloric intake allowed.

In U.S. Pat. No. 4,828,498, a method and “kit” of components for implementing a diet using color co-coordinated food exchange cards to match foods of the major food groups in a food exchange list is described. Self-adhesive labels printed with various meal designations are provided for affixing to the food exchange cards. Other blank labels for writing special instructions are also provided for affixation to the food exchange cards. Each card represents one food exchange and is color co-coordinated to match the colors of the various food groups defined in the aforementioned A.D.A. exchange lists. Food group identifying means are also preferably provided for affixation to selected foods or food packaging for easy identification of the marked food as a member of the indicated major food group.

In U.S. Pat. No. 4,832,603, a diet control system is described which utilizes a display panel and a plurality of movable members mounted upon the display panel. The display panel has seven food group display zones across the top of the panel and six meal display zones across the bottom. The meal display zones are each divided into three parallel columnar zones, one of which contains a list of all of the food groups, the second of which is adapted to receive a numerical designation of the number of food units of each group to be consumed during each meal, and the third of which is adapted to receive movable members indicative of choices of consumable foods and portions of food within each food group. Movable members are contained within each food group zone. Displayed on each of the movable members is a quantity and choice of food to make up one unit of food of a food group. The movable members are movable from the food group zone to the third column of the metal zone in the numbers displayed in the second column of the metal zone so as to display the choice of selected foods for each meal as well as the quantities of those choices.

In U.S. Pat. No. 5,283,865, a computerized system is described which provides a salesperson with assistance related to training and sales of parts corresponding to particular products. More particularly, a computerized system incorporating a data storage device, a display apparatus, a part selection device and a user interface mechanism enhances the efforts of a parts salesman. The data storage device electronically stores graphic and textual parts-related information including specifications, features and customer benefits. The display apparatus electronically displays portions of the graphic and textual information in order to provide training and sales assistance related to part features and customer benefits. The part selection device electronically selects a particular part by navigating through part choices menus based on stored part specifications. The user interface controls the operation of the display apparatus and the part selection device so that each of the respective system parts are operatively coupled and related to one another.

In U.S. Pat. No. 6,039,576, there is described a product display board for display of product lines of memorial products, the display board consisting of a planar member and a plurality of horizontally arranged linear arrays mounted on the planar member. Each array displays one product line and includes a plurality of cells, each cell including a product sample displaying at least one design feature (comprising at least one design option for a memorial product). Each design feature is selected from the group consisting of finishes, borders, border decorations, lettering fonts, personalized designations, floral holders and combinations thereof, wherein each of the design options comprises a plurality of design options, such that each cell displaying a design feature is linearly and vertically arranged with another cell displaying a design feature. The several linearly arranged cells comprise finished product samples.

In U.S. Pat. No. 6,428,320, an apparatus and method are described for determining the quantity of portions of comestibles to be consumed by the user. The apparatus includes a visual cue indicia device having indicia thereon being configured in the shape of a familiar object of a size similar to the size of a desired portion of a comestible product to be consumed. The user can control the quantities of portions of comestible groups being consumed. In one form, the apparatus includes a book having a plurality of pages, at least one of the pages having the visual cue indicia device being removably disposed thereon. The visual cue indicia device preferably includes a paper board sheet having its indicia on the front face thereof which the user must carry so that it can be uses discretely for gauging the size of a portion to be consumed.

In U.S. Pat. No. 6,431,873, there is described use of a preprinted food group triangle sheet having indicia representative of a plurality of food groups thereon. The sheet is sized to be inserted between a first triangular member and a second triangle member. A plurality of apertures extend in complimentary alignment through both the first and second triangular members. The plurality of apertures are positioned in relation to each of the food groups preprinted on a food group triangle sheet. One or more additional apertures may be provided to record the taking of vitamins, minerals or medication. A punch is provided for manual insertion into an aperture selected from a plurality of apertures. A flexible strap may be used to secure the punch to the food group monitoring apparatus. The food triangle sheets may be releasably secured in a pad, or on a page of a book, to provide a lasting record of the quantity and selection of foods consumed according to food groups, over time.

In U.S. Pat. No. 6,585,516, there is described a system and method for computerized visual behavior analysis, training, and planning. The system includes a user interface, a meal database, a food database, picture menus, and a meal builder. In this method, the meal database and the food database are prepared. Then, the user references the picture menus to choose meals for a particular time period to correspond to a customized eating plan. Next, the user is given the option to decide whether or not to change one or more of the meals he/she has chosen for the particular time period. If the user decides to change his/her chosen meals, the user can edit or create new meals using the meal builder. If the user decides not to change his/her choices, or after the user changes his/her choices, the user can save the meals for the particular time period.

In Japanese Abstract 2002183415, published Jun. 28, 2002, there is described a method and system for providing information to a consumer with respect to a specific condition of the consumer. A server includes a database which can be accessed through a mobile terminal and displayed on a display screen.

In Japanese Abstract 2003067607, published Mar. 7, 2003, there is described a procedure whereby a computer user may access the Internet to advance to “deeper” information displayed on the computer's monitor to provide various information (e.g., price, function, material identification) for a selected commodity.

The teachings of the publications provided at these locations by said organizations, and the other organizations cited earlier in this specification (e.g., the A.D.A.), as well as the other documents listed hereinabove, are incorporated herein by reference.

While the above guides, programs, etc. have proven somewhat helpful in assisting persons to choose their food products, these are often difficult and time-consuming to learn and utilize effectively, lack much of the necessary information a consumer needs at the purchasing location to make a fully informed decision, and do not provide the retailer with adequate means to identify his/her food products in a facile manner that is easy for the consumer to read and comprehend.

It is thus believed that a method of effectively identifying various food products in such a manner that a consumer can readily discern many essential aspects thereof desired and needed by the consumer, and that a retailer can readily implement in order to so properly identify his/her food products for sale, will represent a significant advancement in the art.

### OBJECTS AND SUMMARY OF THE INVENTION

It is, therefore, a primary object of the invention to enhance the art of food identification and selection.

It is another object of the invention to provide a new and unique method and system for identifying food products in accordance with several criteria which allows the consumer to readily ascertain whether said food products meet his/her selection requirements.

It is another object of the invention to provide such a method and system which can also be readily accessed and implemented by the food product retailer in order to properly provide food products sold by said retailer, and is accessible by food manufacturers and various established organizations to enable these parties to provide necessary input so as to satisfactorily assure such food product identification.

It is still another object of the invention to provide such a method and system which is relatively inexpensive to use and install, respectively.

According to one aspect of the invention, there is provided a method of identifying particular attributes of various food products to human consumers such that said human consumers are able to selectively choose said food products according to their particular nutritional lifestyles, the method comprising the steps of providing a database including a listing of various food products and at least one specific nutritional code for each of the food products with respect to various human consumer nutritional lifestyles, providing food retailers access to this database so as to enable the retailers to provide inputs thereto, including information with respect to how the retailers mark food products, also providing human consumers access to the database to enable these consumers to obtain specific information with respect to food products, including the specific nutritional codes associated therewith, providing information to food manufacturers to assist the food manufacturers to determine a specific nutritional code for each food product that the food manufacturer produces, providing food retailers with comparative indicia material for display to human consumers who might purchase food products, and providing the food retailers having this comparative indicia material with access to the database such that these food retailers can obtain selected information from the database to enable the retailers to mark various food products with one or more of the specific nutritional codes according to the nutritional lifestyles of the human consumers to enable these consumers to choose selected ones of the food products according to the specific nutritional code thereof.

According to another aspect of the invention, there is provided a system for identifying particular attributes of various food products to human consumers such that these human consumers are able to selectively choose food products according to their own particular nutritional lifestyles, the system comprising a database including a listing of various food products and at least one specific nutritional code for each food product with respect to various human consumer nutritional lifestyles, means for allowing food retailers access to the database so as to enable the food retailers to provide inputs thereto, including information with respect to how these food retailers mark the food products, means for allowing the human consumers to access the database to enable these human consumers to obtain specific information with respect to food products, including the specific nutritional codes associated therewith, means for providing information to food manufacturers to assist the food manufacturers to determine a specific nutritional code for each food product the food manufacturer produces, means for providing food retailers with comparative indicia material for display to human consumers who might purchase food products from the food retailers, and means for providing the food retailers having the comparative indicia material access to the database such that the food retailers can obtain selected information sufficient to enable the retailers to mark various food products with one or more specific nutritional codes according to the nutritional lifestyles of the human consumers and thus enable the human consumers to choose selected ones of the food products according to said specific nutritional codes thereof.

### BRIEF DESCRIPTION OF THE DRAWINGS

The preferred embodiments of the invention will be defined in greater detail hereinbelow, with reference to the following Drawing FIGURES., wherein like designations may be used to designate like elements from FIG. to FIG.

In FIG. 1, there is illustrated the U.S.D.A. Food Guide Pyramid mentioned hereinabove;

FIG. 2 is a schematic illustration of a system in accordance with one embodiment of the invention;

FIG. 3 is a table showing four columns: (1) a listing of possible nutrients; (2) a listing of possible ingredients and processing methods; (3) a resulting nutritional code; and (4) a listing of possible comparative lifestyles;

FIG. 4 illustrates the table of FIG. 3 indicating a particular selection a retailer choose to mark his/her food products for eventual purchase by consumers;

FIG. 5 is a “Reference Chart” with representative examples of various nutritional codes that may be produced when selecting predetermined ones of the items listed in the first two columns (Nutrients, and Ingredients and Processing), respectively, of the Table in FIG. 3;

FIG. 6 illustrates one embodiment of a nutritional code which can be produced when using the system taught herein;

FIG. 7 illustrates another embodiment of a nutritional code which can be produced using the system taught herein, this particular code also including additional information over that shown in FIG. 6; and

FIG. 8 illustrates one embodiment of a food product label that can be produced using the teachings of the invention, including the code illustrated in FIGS. 6 and 7, and additional readable information (i.e., here, a barcode).

### DETAILED DESCRIPTION OF THE PREFERRED EMBODIMENTS

For a better understanding of the present invention, together with other embodiments and aspects thereof, attention is directed to the following detailed description in conjunction with the above-provided Drawings.

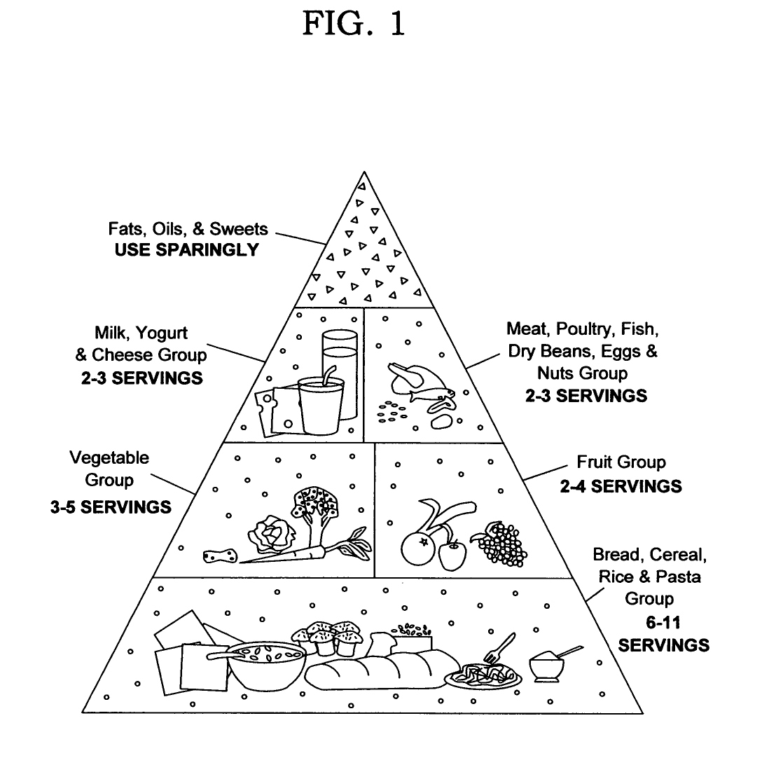

In FIG. 2, there is shown a system 11 for identifying particular attributes of various food products such that human consumers 13 are able to determine from the labeling on such products whether these products meet the particular nutritional lifestyles of such consumers. The term “nutritional lifestyle” is defined hereinabove and, in summary, defines a lifestyle of several categories according to a consumer's needs and/or desires. These categories include disease prevention, disease management, weight control, performance, allergens (resistance to allergies) and, what may be referred to here as “other”. In the case of disease prevention, for example, it may be the consumer's need to prevent hyperglycemia or to promote good health or other positive attributes of one's system. It is also within the scope of the invention, based on recent information, to help to prevent the possible onset of cancer in some forms through such proper food selection. With respect to disease management, the invention is designed to assist consumers who presently have one or more diseases to effectively deal with same and hopefully live a peaceful, satisfactory life. Examples of such diseases which can be managed using proper dietary control as taught herein include diabetes, hypertension, heart disease, gastrointestinal infections, etc. With respect to weight control, the aforementioned statistics clearly show that this is of great significance to many consumers today and is obviously one of this country's leading health problems. Consumers desiring to maintain effective weight control are particularly concerned with controlled carbohydrate intake, controlled fat intake, and a diet low in calories.

Yet another lifestyle, as mentioned above, involves attaining performance goals (e.g., increased cardiovascular rates) and, as understood, the proper dietary controls taught herein will enable such performance goals including, e.g., such cardiovascular improvement, muscular strength, muscular endurance, flexibility, etc. Understandably, the selection of proper food products serves only to assist the consumer in improving muscular strength as it is well understood that such individuals need also to do an appropriate amount of physical exercise and satisfy other personal goals (e.g., eliminate smoking) in order to seek and attain optimal performance.

Yet another lifestyle, as stated, involves the selection of proper food products to avoid certain allergens. Specific examples include glucose and lactose intolerance and the aforementioned “Big 8” allergens (milk, eggs, fish, peanuts, wheat, soybeans, tree nuts and crustaceans). With particular attention to the “other” lifestyle, these may be in various categories such as economic and informational. By way of example, specific food products as quoted herein may allow the consumer to purchase relatively lower cost products in the same category (e.g., meats), whereas on the informational front, the instant invention serves to inform the uneducated consumer as to several characteristics of various food products that the consumer may elect to consider for purchase. Transcending all of the above lifestyles are of course the dietary needs and desires of various age groups, from the very young to the relatively older population. Understandably, younger children such as babies consume and require relatively high caloric food products while older citizens, having reduced metabolism, do not. Still further, transcending the above lifestyles can also involve religious issues such as the need for Kosher-prepared food products. Still further, there are many persons, including those in one or more of the aforementioned lifestyles, who insist on food products that are prepared in a specific manner, e.g., naturally grown, organic grown, pesticide-free, etc.

As understood from the teachings herein, the present invention is uniquely able to satisfy all of the above lifestyles by providing a food product consumer/purchaser with the substantial amount of readily discernible information to enable the consumer/purchaser to be fully informed and make a proper (and, if especially of concern, safe) selection of a respective food product.

System 11, as shown in FIG. 2, includes a database 15 which, understandably, represents the “heart” of this invention. This database includes appropriate software and programming to collect extensive information in many forms and types and to assimilate this into an appropriate format for subsequent processing (in a particular example, preparation of food labels have the defined nutritional codes herein). According to one aspect of the invention, the database receives and stores information from various known organizations including food manufacturers 17, the American Diabetes Association 19, the U.S. Department of Agriculture 21, the National Institute of Health 22, the American Cancer Society 23, and what is shown in FIG. 2 as Others 25. Others in this sense may include the American Dietetic Association and other health organizations which are capable of providing information to database 15 in a required format, or in a form that can be readily formatted and used effectively by the software. It is also shown in FIG. 2 that food retailers 31 will provide input to database 15, one example being how these retailers mark such products.

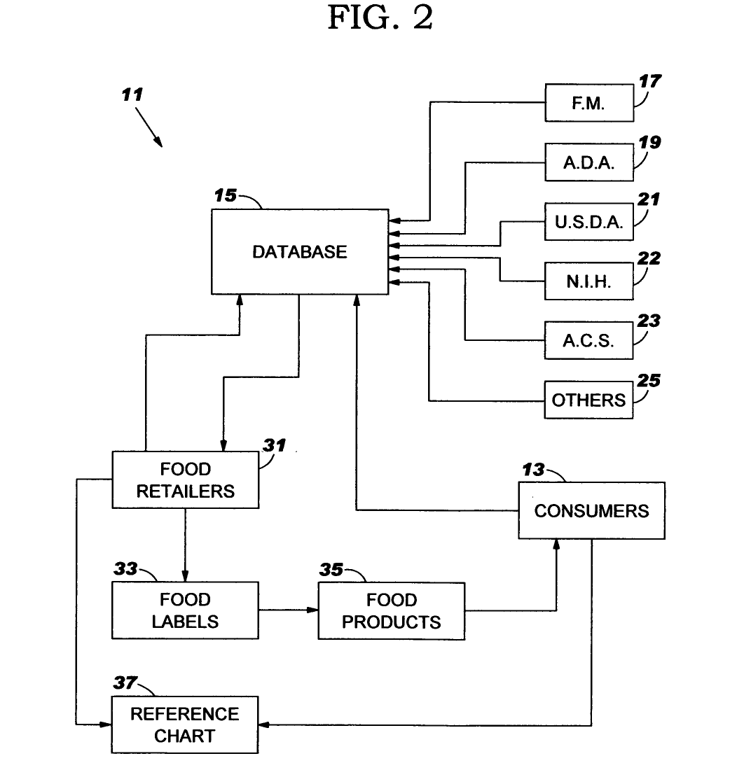

As stated, the information provided by these organizations and others may be in several different forms and types, but is collected and assimilated for presentation in a suitable format for subsequent processing. Examples of such information include the various nutrients of identified food products, including proteins, carbohydrates, fats, vitamins, minerals and amino acids. With respect to protein, the source of the protein may be inputted while for carbohydrates, fats, vitamins, minerals and amino acids, the specific types of these may be inputted. Attention is directed to FIG. 3 for the table shown therein wherein examples of such nutrients are illustrated and listed in the column on the left side of the table.

Additional information which may be inputted into database 15 include whether the various food products are naturally or organic grown or prepared in a Kosher style. As shown in column two in FIG. 3, this processing and ingredients column may further include what is referred to as “standard” processing. By the term “standard” is meant one which is controlled by the standards of the U. S. Department of Agriculture for health and safety. That is, these pertain to any processes utilized to produce such food products which meet said standards. Shown also in column two (second from the left) in FIG. 3 is the term “non-GMO” processing, which means non-Genetically Modified Organisms. A classic example of a food product subjected to genetic modification of this type is corn, as it is known that several varieties of such product currently on market shelves today is so grown. The ingredients and processing information listed in column two of FIG. 3 is not meant to limit the invention in that other information in these categories is also possible. Typically, such information will come from the food manufacturers 17 with regard to whether the food products they grow and/or process (including slaughter) are done in a specific manner. The above is only representative of inputs and others are, of course, possible.

Once this information is gathered within database 15, the selected program(s) process the information in a consistent manner to provide the food retailers 31 with such information. For example, various vegetable items such as bananas, carrots, celery, etc. may be marked substantially different than canned goods or boxed products such as mixes, powders, etc. This information from the food retailers is especially important because it will determine how the collected information is formatted for subsequent application of the resulting nutritional codes to the respective labels 33 which are then provided on the selected food products 35. By way of example, supposing that a rectangular label for attachment to a package of carrots were to be utilized, this would likely include different criteria, in addition to the defined nutritional code provided hereby, that the consumer may desire or need to see. As a specific example, the food retailer may desire to present his/her fish products with labels in the shape of a fish, apples in the shape of an apple, etc. The invention is uniquely able to accomplish this as well.

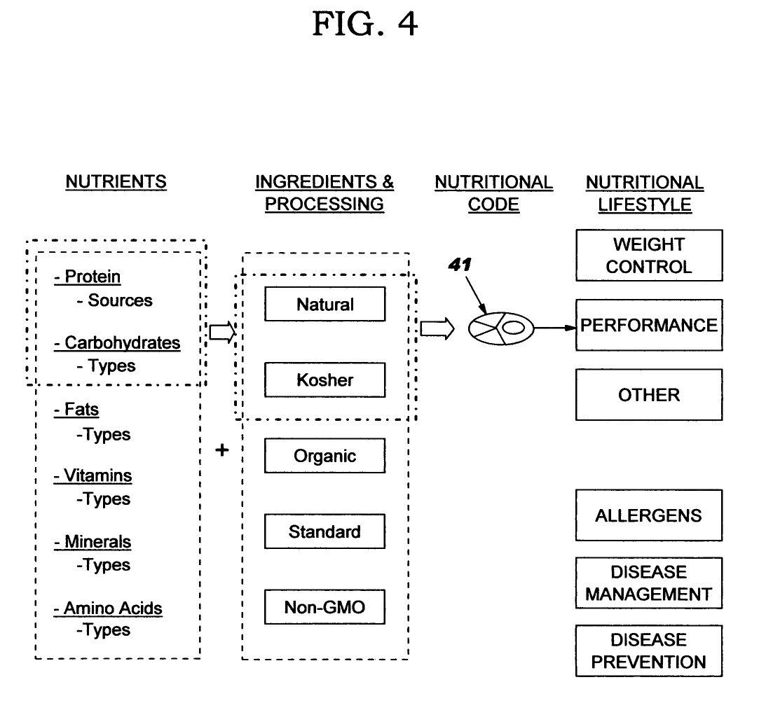

In FIG. 2, it is also shown that the food retailer may provide a reference chart 35, one example being illustrated in FIG. 5. Further description of FIG. 5 will be provided hereinbelow.

According to one embodiment of the invention, the food retailers are the parties responsible for preparing the necessary food labels which will contain the nutritional information derived from database 15. These labels will include the nutritional codes defined in greater detail below in addition to added information which is deemed necessary for the eventual consumer. Still further, it is within the scope of the invention that the food retailer may provide his/her own separate information on these food labels, depending on the environment of his business establishment. For exarnple, a food retailer in a predominantly Italian-American neighborhood may desire to further add information desired by such residents, including, for example, in the Italian language. As stated, the food retailer may also desire to provide resulting food labels of specific configurations, possibly also relative to his/her consumer base. These possibilities and more are attainable using the unique teachings of the present invention, thus illustrating the significant versatility thereof.

In FIG. 3, the aforementioned table is shown. The result of combining the information relative to the nutrients in column one with the ingredients and processing information in column two produces a specific nutritional code 41 as also illustrated in FIG. 3. This code 41 in turn contains specific information sufficient to enable the food product purchaser to determine whether the code is appropriate for the particular nutritional lifestyle desired, examples of which are shown in the fourth column in FIG. 3 (e.g., performance, disease prevention, etc.). More description of the specific code shape and contents will be provided below.

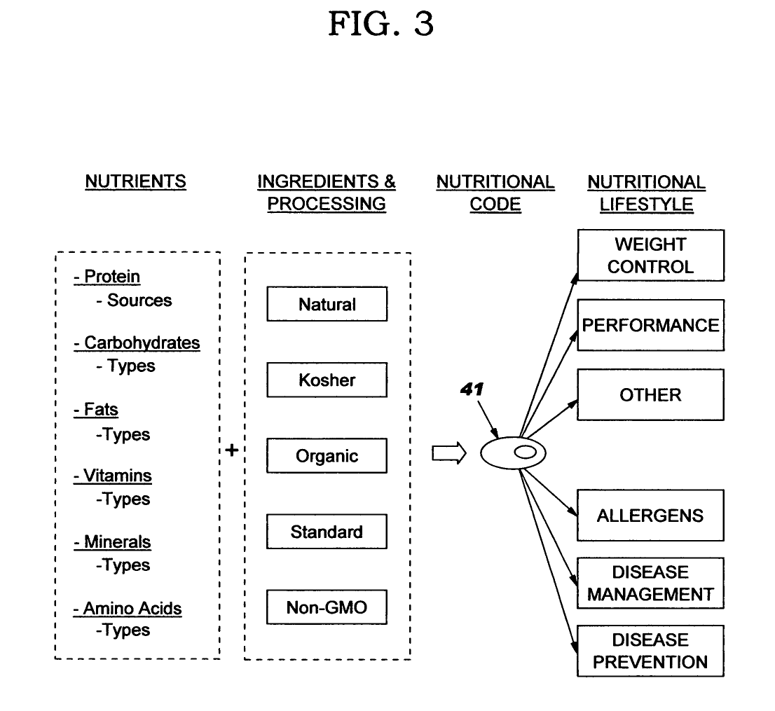

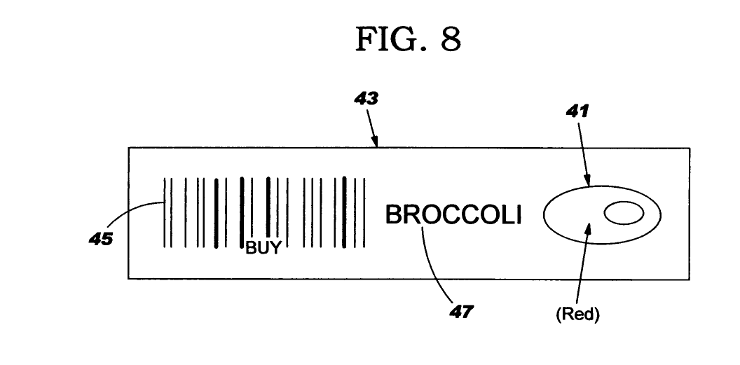

In FIG. 4, there is shown one example of how this system is intended to operate. For example, if the food retailer has a specific food product that includes only natural ingredients and is prepared according to Kosher doctrine, he/she may also add to this resulting code the protein source and types of carbohydrates. The resulting code 41 will be produced. Understandably, this code is but one form of information that may be provided to the eventual consumer. That is, the code is preferably included with other information such as that typically represented by barcodes or the like and other information. An example is shown in FIG. 8, wherein the resulting label 43 is shown to include a nutritional code 41 of the type described herein in combination with a barcode 45 and a specific English language term (here, broccoli) 47, defining the particular food item. The example shown in FIG. 4 is illustrative only and not meant to limit the invention as it is understood from the description herein that the food retailer may elect to procure several types of information from database 15 when preparing his/her food labels. It is possible, for example, to provide an abbreviated and relatively small form of a food pyramid as shown in FIG. 1 to indicate whether the particular food item marked lies within one of the four levels shown (i.e., Fruit Group). As also mentioned above, it is also possible to include pricing information in order to inform the purchaser whether the initially selected food product is the lowest priced compared to other similar products available at the particular retail establishment. The first and second columns in FIGS. 3 and 4 are shown for the purpose of indicating the respective information which is designed for producing a nutritional code 41 such as that to be described further herein.

In FIG. 5, there is shown the aforementioned reference chart 35. While in black and white, it is understood that the various elements shown therein are color-coded according to an established standard, these colors indicated in parenthesis adjacent the designated objective. As shown, the first nutritional code 41 is colored red and designed to indicate that the resulting food product is particularly desirable for establishing sound heart health. Further, the second nutritional code 41′ is blue and designed to substantially prevent the onslaught of diabetes or, equally important, to assure the consumer a proper diet designed to accommodate such a disease. The nutritional codes 41″, 41′″, ″″″ and 41′″″ are designed for allergen prevention (green), performance (purple), weight control (orange), and prevention of cancer (brown), respectively. The reference chart of FIG. 5 is illustrative only and will preferably include several additional nutritional codes than the six illustrated. This reference chart, including what is defined as comparative indicia material to produce the respective nutritional codes, is provided for ready access at the food retailer's establishment by the consumers. Such access is preferably by electronic means, one example being a computer monitor where a touch tone or the like screen is utilized. Additional electronic means are also possible, including a telephone or the like connection and, using more advanced technology, a wireless type of connection. Each of these types of connections are usable in the present invention for providing the various connections between the database and the food retailers as well as that between the database and the consumers (as stated) and the database and inputting organizations shown in FIG. 2. One primary objective, therefore, of the present invention is to provide positive information to retailers and consumers to enable the consumers to make an educated determination of the respective food product they desire while still assuring that the food retailer will provide an accurate, detailed nutritional code and other necessary information essential for the consumer to make such a choice.

Another form of an electronic means usable to connect consumer/purchaser with the database 15 can be a hand-held “mini” computer/scanner (not shown) which is capable of scanning the various bits of information provided by each nutritional code to in turn provide the consumer/purchaser with an ongoing summation of desired nutritional and other information such as total calories, proteins, carbohydrates and sugars, as well as comparative price to other, similar items in this category. The consumer can thus “track” his/her individual consumptions of these elements when consuming the food product. This hand-held electronic component could also be programmed to enable the user to input his/her own personal lifestyle (e.g., vegetarian) so as to select only products which satisfy same, including showing the user the designated location in the retail establishment where such products are displayed. Such a component may also have stored therein the person's own particular medical (e.g., diabetic) and other information (e.g., relative weight) which can be compared to the incoming code information to enable the user to assure compliance. The component could then be accessed by one's own personal physician (e.g., during a doctor visit) in order to assist the medical professional in addressing the physical problems of the visiting patient. Preferably, such an electronic component would be wireless, and may even form part of a presently known component such as a cell phone or smart phone.

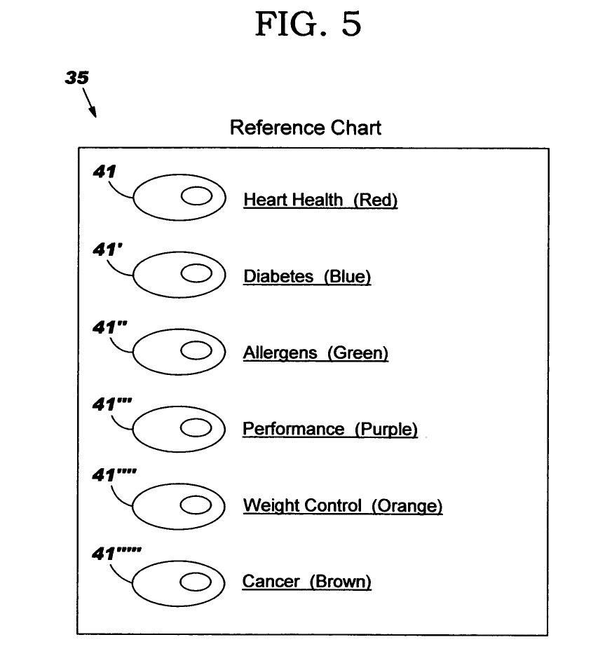

FIG. 6 represents an alternative embodiment of a nutritional code 41A which may be produced from the database information provided the food retailers 31. The example shown in FIG. 6 is predominantly green (indicating the presence of at least one allergen), but further includes a red portion to indicate heart health promotion and an orange portion to indicate the food product assists in weight control. The respective size of each color coded portion may further determine the relative importance of this product to the respective lifestyle desired. For example, if the consumer is especially concerned with obtaining a non-allergic food item, a nutritional code not including the color green will be provided. Should this same consumer further desire to obtain a product which also fights diabetes, for example, a portion of code 41A could be blue. It is possible that a resulting code may include all colors if the food product is able to meet such criteria as stipulated herein.

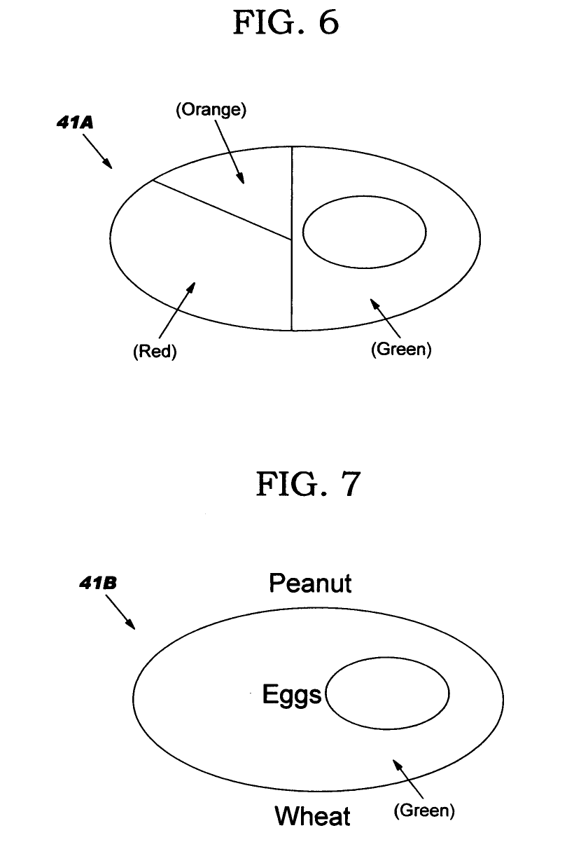

In FIG. 7, the functional code 41B is intended to show the consumer that the food product contains various allergens (here, a peanut source, eggs and wheat) in addition to a singular color indicating the food product is an allergen.

Although a computer monitor and terminal have been described as one example of providing a reference chart, it is anticipated that many food retailers may elect to utilize a hardcopy form of such a chart in relatively large format for ease of reference by the respective customers. Such a reference chart may be positioned immediately upon entry within the food retailer's establishment, as well as at other locations within this establishment (e.g., above each aisle). As indicated, it is also within the scope of the invention to provide a scanner at the retail establishment which will allow the consumer/purchaser to scan selected coded products and read on the monitor of the scanner the information provided.

Thus there has been shown and described a method and system for particularly identifying food products according to several various attributes and criteria thereof in which a database containing this extensive information for each food product is accessible by electronic means (including wired connections such as by computer or telephone, and wireless such as by radio frequency (RF)) by the consuming public and, equally significant, by food retailers such that the latter may provide specific nutritional codes on food labels on such products. The database includes information from several known organizations and may further include additional information as deemed necessary and appropriate in order to provide as much necessary information for each food product as is considered necessary. The invention as taught herein assures that a consumer is properly informed so as to reach a proper decision in accordance with his/her own personal nutritional lifestyle to thus promote this person's health and longevity. The invention as defined is readily capable of being implemented throughout the country and elsewhere using known technologies and is thus relatively inexpensive to establish and utilize. Software programming capable of receiving and assimilating the extensive information from the various sources described herein is also attainable and will require subsequent modification depending on the inputted information and the extent of which is desired by the respective food retailers and his/her own customers. As stated, this information can be tailored to various consuming environments such as those of different ethnic and other backgrounds. Equally significant, the respective food labels are capable of including much more information than that provided by the nutritional codes illustrated herein. It is also understood that such nutritional codes as so illustrated are not meant to limit the scope of the invention because other code shapes and criteria may be utilized. For example, a singular nutritional code in the form of a barcode may be possible, as well as one of a particular shape (e.g., of a fish, as stated).

The invention as taught includes many capabilities and attributes not attainable or offered by the various systems described hereinabove. This invention thus represents a significant advancement in the art, especially considering today's needs for greater nutritional inputs for the consuming public. The corresponding significant emphasis placed on greater health by the various organizations described herein and others (including the U.S. government), are all intended to promote better health.

While this invention has been defined in conjunction with specific embodiments provided in detail hereinabove, it is evident that various alternatives, modifications and variations thereof will be apparent to one skilled in the art. Accordingly, the recited embodiments above are intended not to be limiting but only for illustrative purposes. Various changes may be made without departing from the spirit and scope of the invention as defined by the appended claims.

1. A method of identifying particular attributes of various food products to human consumers such that said human consumers are able to selectively choose said food products according to their particular nutritional lifestyles, said method comprising:
providing a database including a listing of various food products and at least one specific nutritional code for each of said food products with respect to various human consumer nutritional lifestyles;
providing food retailers access to said database so as to enable said food retailers to provide inputs thereto, including information with respect to how said food retailers mark said food products;
providing human consumers access to said database to enable said human consumers to obtain specific information with respect to said food products, including said specific nutritional codes associated with said food products;
providing information to food manufacturers to assist said food manufacturers to determine a specific nutritional code for each food product said food manufacturer produces;
providing food retailers with comparative indicia material for display to said human consumers who might purchase food products from said food retailers; and
providing said food retailers having said comparative indicia material with access to said database such that said food retailers can obtain selected information from said database to enable said food retailers to mark various food products with one or more of said specific nutritional codes according to the nutritional lifestyles of said human consumers to enable said human consumers to choose selected ones of said food products according to said specific nutritional codes.

2. The method of claim 1 wherein said database includes information obtained from various known organizations.

3. The method of claim 2 wherein said various known organizations include the U.S. Department of Agriculture, the National Institute of Health, the American Cancer Society, the American Diabetic Association and the American Dietetic Association.

4. The method of claim 1 wherein said food retailers are provided access to said database by electronic means.

5. The method of claim 4 wherein said electronic means include telephone, computer, and wireless connections.

6. The method of claim 1 wherein said consumers are provided access to said database by electronic means.

7. The method of claim 6 wherein said electronic means include telephone, computer, and wireless connections.

8. The method of claim 1 further including displaying said comparative indicia data to said human consumers by said food retailer.

9. The method of claim 8 wherein said displaying is accomplished using accessible computer terminals, open displays, wireless devices, and the like.

10. The method of claim 1 wherein said information provided to said food manufacturers is provided by electronic means.

11. The method of claim 11 wherein said electronic means include telephone, computer, and wireless connections.

12. A system for identifying particular attributes of various food products to human consumers such that said human consumers are able to selectively choose said food products according to their particular nutritional lifestyles, said system comprising:
a database including a listing of various food products and at least one specific nutritional code for each of said food products with respect to various human consumer nutritional lifestyles;
means for allowing said food retailers to access said database so as to enable said food retailers to provide inputs thereto, including information with respect to how said food retailers mark said food products;
means for allowing said human consumers to access said database to enable said human consumers to obtain specific information with respect to said food products, including said specific nutritional codes associated with said food products;
means for providing information to food manufacturers to assist said food manufacturers to determine a specific nutritional code for each food product said food manufacturer produces;
means for providing food retailers with comparative indicia material for display to said human consumers who might purchase food products from said food retailers; and
means for providing said food retailers having said comparative indicia material access to said database such that said food retailers can obtain selected information from said database to enable said food retailers to mark various food products said food retailers sell with one or more of said specific nutritional codes according to the nutritional lifestyles of said human consumers to enable said human consumers to choose selected ones of said food products according to said specific nutritional codes.

13. The system of claim 12 wherein said database includes information obtained from various known organizations.

14. The system of claim 13 wherein said various known organizations include the U.S. Department of Agriculture, the National Institute of Health, the American Cancer Society, the American Diabetic Association and the American Dietetic Association.

15. The system of claim 12 wherein said means for allowing said food retailers and said human consumers access to said database, said means for providing information to said food manufacturers, and said means for providing said comparative indicia material to said food retailers comprises electronic means.

16. The system of claim 15 wherein said electronic means include telephone, computer and wireless connections.

17. The system of claim 12 wherein each of said nutritional codes is color-coded.

18. The system of claim 17 wherein each of said nutritional codes include more than one color.

19. The system of claim 17 wherein each of said nutritional codes further includes additional readable information.

20. The system of claim 17 wherein each of said nutritional codes further includes additional language information.
